(19) United States
(12) Patent Application Publication
(10) Pub. No.: US 2008/0061239 A1
(43) Pub. Date: Mar. 13, 2008

(54) Non-invasive active infrared triggering device to monitor amphibian and other animal life in aqueous environments

(76) Inventor: Marta Levesque Bryan, Sisters, OR (US)

Correspondence Address: Marta Levesque Bryan, 526 E. Tyee Dr., Sisters, OR, 97759, US

(21) Appl. No.: 11/519,661

(22) Filed: Sep. 12, 2006

(51) Int. Cl. G01J 5/02

(52) U.S. Cl. 250/341.1

(57) ABSTRACT

A non-invasive active infrared device monitors amphibians and other animals in aqueous environments. An infrared emitter circuit and an infrared detector circuit are secured in a horizontal orientation with respect to each other in a u-shaped Plexiglas structure. A combination of variable resistors, a focusing lens, and a funnel allows the detector circuit to detect a pre-selected size of aquatic animal, and by extension a pre-selected species of aquatic animal. When an aquatic animal of a pre-selected size breaks the infrared beam, an event logger is triggered and records the date and time the beam is broken. This device provides a new and enormously useful system for studying the movement patterns and thus key behavioral traits of aquatic amphibians and other aquatic animals.

### FEDERALLY SPONORED RESEARCH

Not Applicable

### SEQUENCE LISTING OR PROGRAM

Not Applicable

### BACKGROUND OF THE INVENTION

1. Field of the Invention

This invention relates to active infrared monitors, specifically to an apparatus that records and monitors movements of amphibian and other animal life in aqueous environments.

2. Prior Art

Researchers of aquatic amphibians and other aquatic animals go to great lengths to try to determine key behavioral traits by studying movement patterns of these animals. Common practice to track aquatic amphibians, in particular, in order to record their movement patterns, has been to use PIT tags, or passive integrated transponder tags. These PIT tags, such as the PIT tag in U.S. Pat. No. 6,400,338 to Mejia et al, Jun. 4, 2002 are small microchips approximately the size of a rice kernel. Each PIT tag has an identification number that can be read with a hand-held scanner. Researchers capture aquatic amphibians. First-time-captured aquatic amphibians are implanted with a PIT tag, and once the date and time and other data from this initial capture is recorded, they are released back into their capture sites. Recaptured aquatic amphibians, with PIT tags already implanted, are scanned and their identification numbers recorded, along with the date and approximate time of their recapture and other data. They are also released back into their capture sites. Over time and multiple captures and recaptures, capture histories for tagged aquatic amphibians emerge, and researchers are then able to draw limited conclusions about aquatic amphibian movement patterns.

This method of using PIT tags is unsatisfying and unreliable. It does not provide the specific time of day that many aquatic amphibians and other aquatic animals pass a monitored location. It does not tell whether an aquatic amphibian or other aquatic animal travels in groups, or if movement patterns vary with each stage of the aquatic animal's life cycle. It does not tell other detailed information regarding the movements of aquatic amphibians and other aquatic animals. In addition, groups of tagged aquatic amphibians might escape recapture, or previously tagged aquatic amphibians might lose their PIT tags. In both circumstances, the data is affected. Since PIT tags frequently provide haphazard data, it is difficult to draw conclusive results about aquatic amphibian and other aquatic animal movement patterns and behavioral traits using PIT tags.

In recent years, active infrared technology has been used in animal tracking fields. Although not specifically adapted to amphibian and other animal monitoring applications in aqueous environments, the active infrared tracking monitor in U.S. Pat. No. 5,128,548 to Goodson et al, Sep. 30, 1987 uses an infrared transmitter and an infrared receiver on land. The transmitter and receiver are mounted on two trees horizontally opposed to each other to monitor and record the date and time an animal enters the monitored location. This device, primarily built for hunters to use to find prime spots to hunt large game animals, will record the exact date and time an animal passes through the area when the animal breaks the pulsating infrared beam for a predetermined number of seconds.

Although quite effective on land when in use to monitor large game animals or vehicular traffic, Goodson's active infrared device cannot effectively monitor aquatic animal movements. If one were to set up Goodson's infrared emitter and infrared receiver underwater in waterproof housings, there would be no means to funnel the aquatic animals through the infrared beam. Consequently, many of the aquatic animals would swim above or below or around the infrared beam, and the device would only record the date and time of events for aquatic animals that, by chance, happened to pass through and break the infrared beam.

Moreover, Goodson's active infrared device cannot differentiate aquatic amphibians and other aquatic animals by size. If one can differentiate aquatic animals by size, one can, within reason, differentiate one species of aquatic animal from another. Goodson's active infrared device records the date and time an aquatic animal passes through only if it breaks the beam for a predetermined number of seconds, which directly correlates to the speed with which the aquatic animal passes through the beam. This speed, however, does not vary significantly for aquatic amphibians and other aquatic animals. Consequently, speed cannot be used to differentiate the size of aquatic animals. Goodson's device would record the date and time of all aquatic animals without differentiating one size of aquatic animal from another.

3. Objects and Advantages

Accordingly, several objects and advantages of the invention are:
a. to provide a monitoring device that is non-invasive to aquatic amphibians and other aquatic animals;
b. to provide a monitoring device to detect an aquatic amphibian or other aquatic animal of a pre-selected size, and by extension, a pre-selected species;
c. to provide a monitoring device that guides aquatic amphibians and other aquatic animals through to the infrared beam; and
d. to provide a monitoring device that reliably functions underwater.

Other objects and advantages are:
a. to provide a monitoring device that records the exact date and time an aquatic amphibian or other aquatic animal passes a monitored location and breaks the infrared beam; and
b. to provide a monitoring device that has easily removable detector and emitter circuits and batteries.

Further objects and advantages will become apparent from a consideration of the ensuing description and drawings.

### SUMMARY

In accordance with the present invention, this active infrared monitoring device comprises an active infrared emitter and an active infrared detector in a horizontal orientation housed in a black waterproof Plexiglas u-shaped structure. A funnel or funneling device is attached to the Plexiglas housing to guide aquatic amphibians and other aquatic animals through to the infrared beam. The detector uses a combination of variable resistors and a focusing lens to detect aquatic animals of a pre-selected approximate size. When the pre-selected size of aquatic animal moves through the Plexiglas housing and cuts the infrared beam going from the infrared emitter to the infrared detector, it triggers the detector circuit which subsequently triggers a HOBO® event logger to record the date and time the infrared beam was cut.

### DRAWINGS—FIGURES

FIG. 1 shows a perspective view of the invention without the front of the Plexiglas housing.

FIG. 2 is a view in detail of the Plexiglas structure that the detector circuit's Plexiglas backing slides into in FIG. 1.

FIG. 3 is a view in detail of the Plexiglas structure that the emitter circuit's Plexiglas backing slides into in FIG. 1.

FIG. 4 is a front view of the detector and emitter circuits screwed into their respective Plexiglas backings.

FIG. 5 is a side view of FIG. 4.

FIG. 6 is a view of the Plexiglas structure used to hold the lens; the hole in the center is for the lens and the four surrounding holes are for the nylon screws that secure the lens.

FIG. 7 is a front view of the lens secured by four nylon screws and four nuts in its Plexiglas backing.

FIG. 8 is a side view of FIG. 7.

FIG. 9 is a schematic diagram of the infrared detector.

FIG. 10 is a schematic diagram of the infrared emitter.

FIG. 11 is a perspective view of the Plexiglas housing with a mesh funnel attached.

FIG. 12 is a perspective view of the Plexiglas housing in a funneled trap.

FIG. 13 is a perspective view of the HOBO® event logger connector plug as it fits into the two PC board terminals in the detector circuit.

FIG. 14 is a perspective view of the Plexiglas cover and four Plexiglas flanges welded to the rim of the Plexiglas housing to which the top is attached.

### DRAWINGS—REFERENCE NUMERALS

20 active infrared detector circuit

22 Plexiglas backing for detector circuit 20 and Plexiglas backing for emitter circuit 24

24 active infrared emitter circuit

26 four thin vertical Plexiglas pieces, two on each side of horizontal Plexiglas bottom support 28, used to hold detector circuit 20 upright

27 four thin vertical Plexiglas pieces, two on each side of horizontal Plexiglas support 29, used to hold emitter circuit 24 upright

28 Plexiglas piece welded to Plexiglas housing 36 to support detector circuit 20 from the bottom

29 Plexiglas piece welded to Plexiglas housing 36 to support emitter, circuit 24 from the bottom

30 primary 6V lantern battery for detector circuit 20

32 6V lantern battery for negative input of op amp 72 of detector circuit 20

34 6V lantern battery for emitter circuit 24

36 u-shaped black Plexiglas housing to hold all other parts of active infrared device

38 nylon screws to secure lens 46 to vertical Plexiglas lens holder 48

40 Plexiglas flanges welded to Plexiglas housing 36

42 Plexiglas cover of Plexiglas housing 36

44 HOBO® event logger

46 focusing lens

48 vertical Plexiglas piece that holds lens 46

50 two horizontal Plexiglas pieces welded to Plexiglas backing 22 of the detector circuit 20 and Plexiglas lens holder 48

52 machine screws

54 ¼-inch nylon spacers

56 nuts for machine screws 52 and nylon screws 38

58 washers for machine screws 52

60 1 kΩ variable resistor

62 220Ω resistors

64 infrared emitter

66 infrared detector

68 first 5 kΩ variable resistor

70 100 kΩ resistor

72 LF353 Dual Operational Amplifier

74 1N914 diode

76 10 kQ resistor

78 2N2222 NPN transistor

80 5V DC reed relay

82 ground

84 PC board terminals

86 insulated wires

88 wing nuts

90 second 5 kΩ variable resistor

92 mesh funnel

94 funneled trap

96 1 kΩ resistor

98 weights

100 waterproof twine

102 HOBO® event logger 44 connector wires

104 HOBO® event logger 44 connector plug

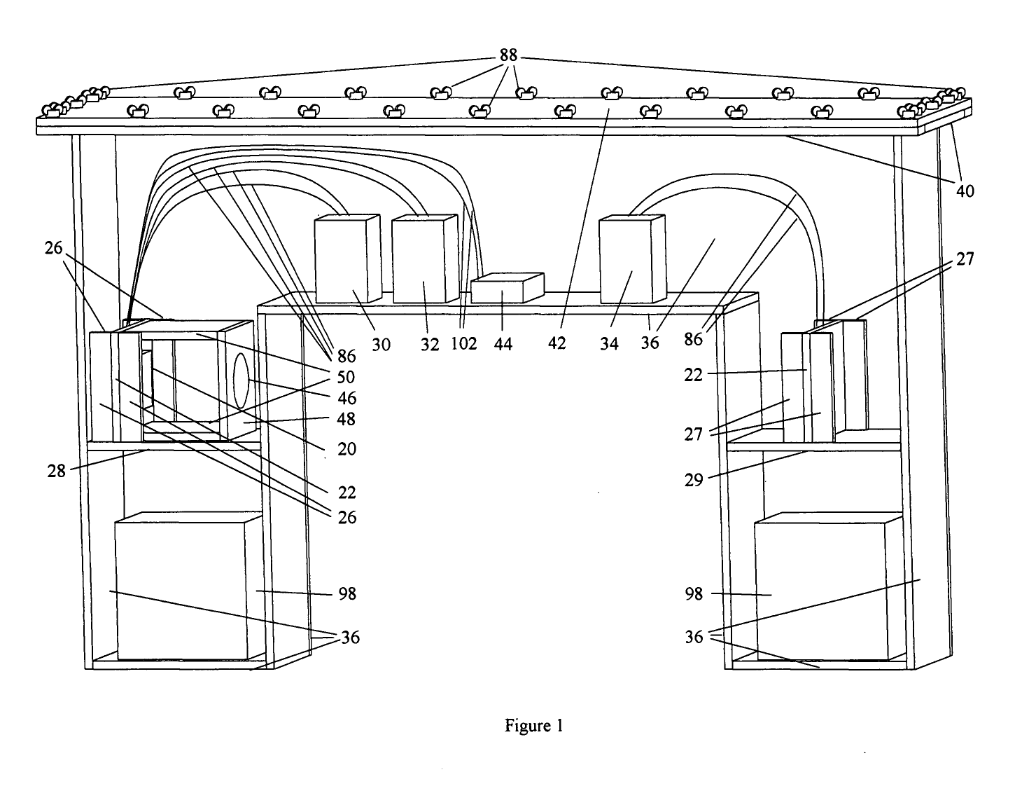

### DETAILED DESCRIPTION—PREFERRED EMBODIMENT—FIGS. 1-14

The apparatus of the present invention employs an active infrared emitter and an active infrared detector to assist in recording the date and time an aquatic amphibian or other aquatic animal of a pre-selected size passes through a predetermined aqueous location. The following description can be more readily understood by referring to FIGS. 1-14.

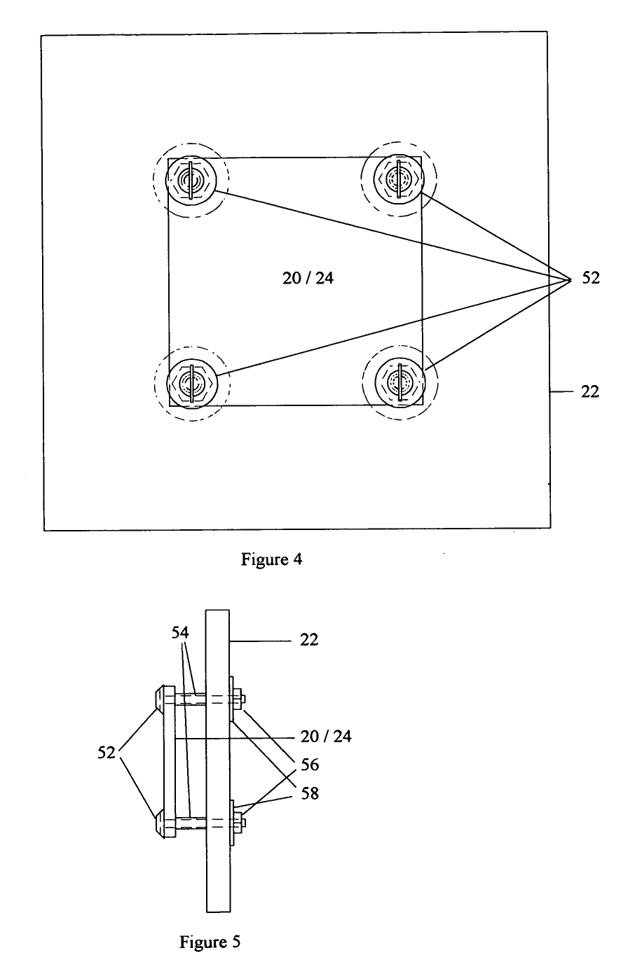

Referring to FIGS. 1, 2-5, and 13, an emitter circuit 24 is attached to a Plexiglas backing 22 with four machine screws 52, four ¼-inch nylon spacers 54, four nuts 56, and four washers 58 through four previously drilled holes (refer to FIGS. 4 and 5). The Plexiglas backing 22 slides in between four thin vertical Plexiglas supports 27, keeping the Plexiglas backing 22 upright and aligned with the detector circuit 20. The vertical Plexiglas supports 27 are welded to the upward side of the bottom Plexiglas support 29. Two vertical Plexiglas supports 27 are welded on each side of the bottom Plexiglas support 29 adjoining and parallel to the long edges of the bottom Plexiglas support 29, positioned approximately in the middle (refer to FIG. 3). The bottom Plexiglas support 29 is in turn welded to a u-shaped black Plexiglas housing 36 (refer to FIG. 1). The bottom Plexiglas support 29 is horizontal and parallel with the bottom of the Plexiglas housing 36. Insulated wires 86 connect the emitter circuit 24 to its 6V lantern battery 34.

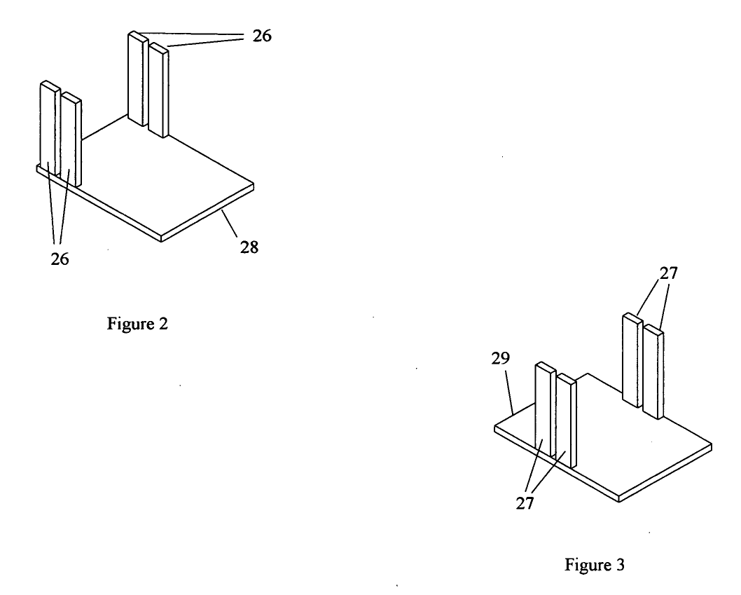

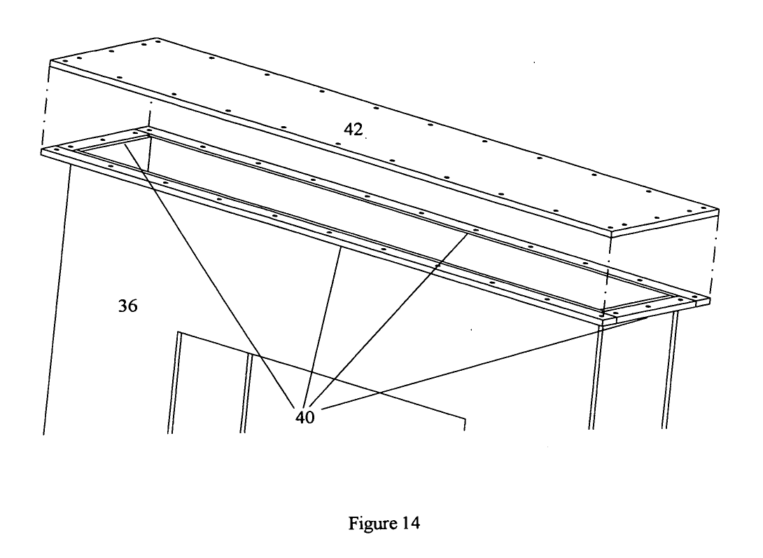

A detector circuit 20 is, like the emitter circuit 24, attached to a Plexiglas backing 22 with four screws 52, four spacers 54, four nuts 56, and four washers 58 through four previously drilled holes (refer to FIGS. 4 and 5). The Plexiglas backing 22 slides in between four thin vertical Plexiglas supports 26, keeping it upright and aligned with the emitter circuit 24. The vertical Plexiglas supports 26 are welded to the upward side of the bottom Plexiglas support 28. Two vertical Plexiglas supports 26 are welded on each side of the bottom Plexiglas support 28 adjoining and parallel to the long edges of the bottom Plexiglas support 28, positioned toward the left end of the Plexiglas support 28 (refer to FIG. 2). The bottom Plexiglas support 28 is in turn welded to the Plexiglas housing 36 (refer to FIG. 1). A HOBO® event logger 44 is connected to the detector circuit 20 through connector wires 102, a connector plug 104, and two PC board terminals 84 (refer to FIGS. 1 and 13). Insulated wires 86 connect the detector circuit 20 to two 6V lantern batteries, 30 and 32. These batteries 30 and 32, like the battery 34 of the emitter circuit 24, can be replaced by a combination of lower voltage batteries, rechargeable batteries, and/or solar panels or other recharging systems.

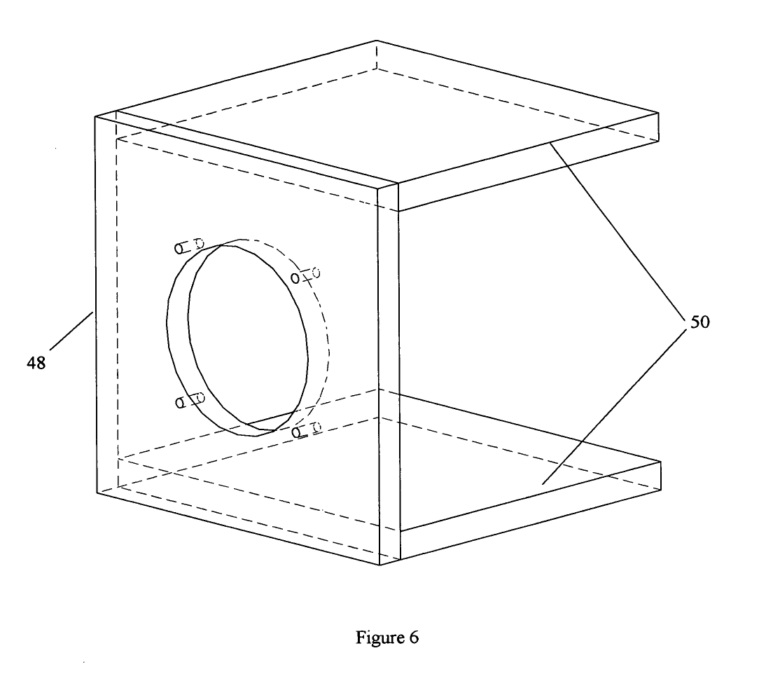

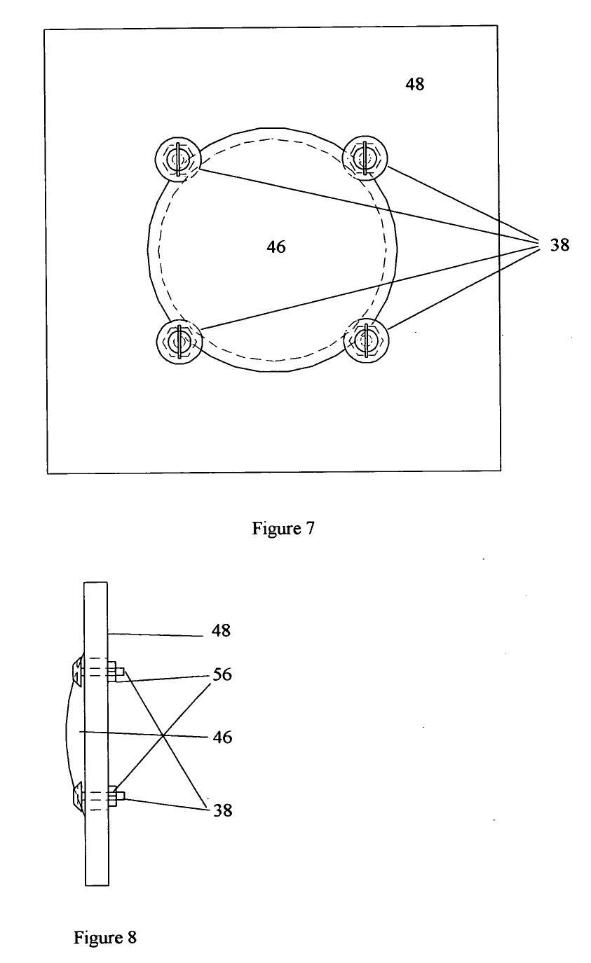

Referring to FIGS. 1-2 and 6-8, focusing lens 46 is clamped down to a vertical Plexiglas lens holder 48 over the central of five previously drilled holes (refer to FIG. 7). The hole in the center of the Plexiglas lens holder 48 for the lens 46 is slightly smaller in radius than the lens 46. The four surrounding holes in the Plexiglas lens holder 48 are for four nylon screws 38 (refer to FIG. 6). The four nylon screws 38 are placed so that their heads slightly overlap the lens 46, keeping it securely fastened to the Plexiglas lens holder 48. Four nuts 56 keep the nylon screws 38 stationary and tight against the lens 46 (refer to FIG. 8). The Plexiglas lens holder 48 is sufficiently smaller horizontally than the Plexiglas backing 22 to enable the latter to slide in between the vertical Plexiglas supports 26, with the following orthogonal construction. Two horizontal Plexiglas pieces 50 are welded at one end to the back of the Plexiglas lens holder 48 at the top and bottom, and are welded at the other end to the front of the Plexiglas backing 22 leaving enough width on either side for the Plexiglas backing 22 to slide in between the vertical Plexiglas supports 26 (refer to FIGS. 1, 2, and 6). The two horizontal Plexiglas pieces 50 are oriented horizontally and parallel to each other. Their lengths must be the focal length of the lens 46, minus the distance from the Plexiglas backing 22 to the infrared detector 66.

Referring to FIGS. 1 and 14, the Plexiglas housing 36, the Plexiglas flanges 40, and the Plexiglas cover 42, in this preferred embodiment, are made of black Plexiglas. All of the seams of this Plexiglas housing 36 are waterproofed with a waterproofing glue or solution. Four Plexiglas flanges 40, extending out from the edge of the Plexiglas housing 36, are welded to the rim of the Plexiglas housing 36 (refer to FIG. 14). The Plexiglas cover 42 has dimensions identical to those of the opening of the Plexiglas housing 36 combined with the dimensions of the Plexiglas flanges 40. The Plexiglas cover 42 is secured to the Plexiglas housing 36 with machine screws 52 and wing nuts 88 (refer to FIG. 1). These screws 52 and wing nuts 88 are screwed into holes previously drilled in the Plexiglas flanges 40 and the Plexiglas cover 42.

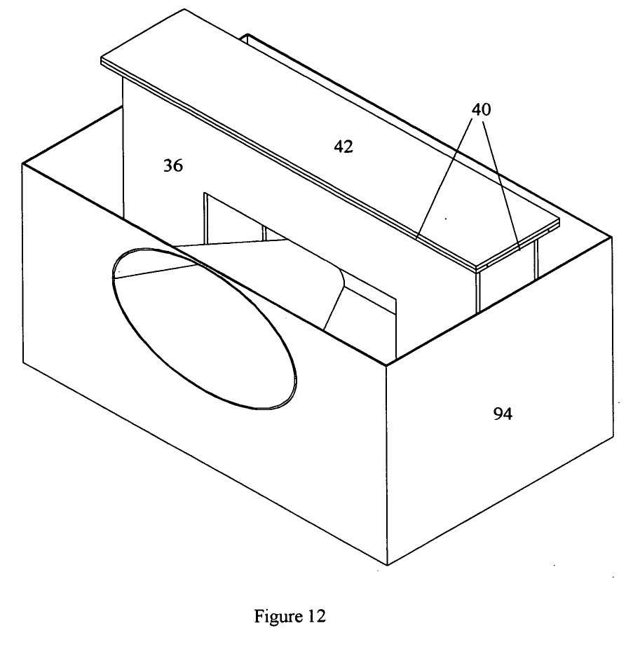

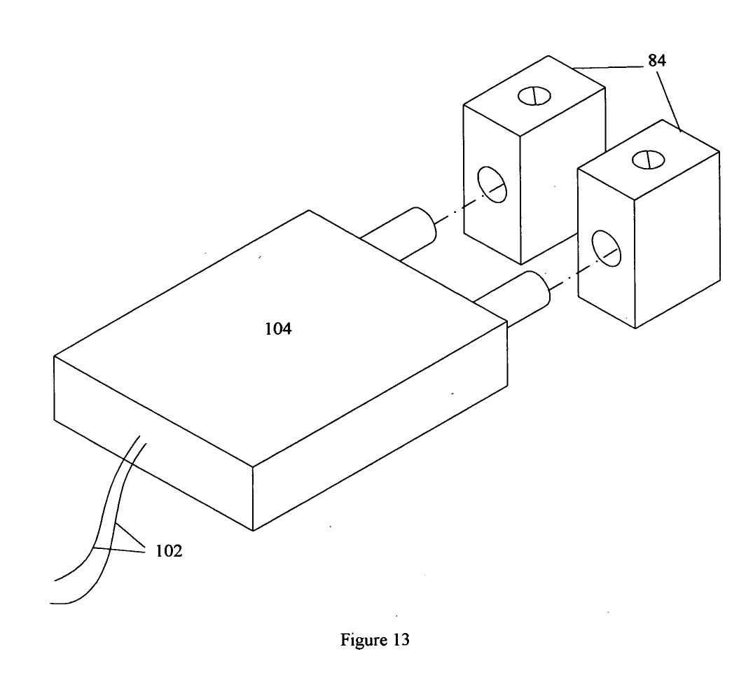

Referring to FIGS. 1, 11, and 12, the Plexiglas housing 36 should be placed in a narrow outlet or other relatively narrow aqueous environment. This improves the chances of a larger number of aquatic animals swimming through the device. The Plexiglas housing 36 can then either be placed in a trap with a funneled opening 94 (refer to FIG. 12), or can have a mesh funnel 92 attached to it (refer to FIG. 11). In this preferred embodiment, the funnel 92 is attached to the Plexiglas housing 36 with waterproof twine 100, looped through the top and the two sides of the funnel 92 and around the top and the two sides of the Plexiglas housing 36. However, the funnel 92 can be attached to the Plexiglas housing 36 in any way that doesn't disrupt the path of the infrared beam and doesn't affect the waterproof nature of the Plexiglas housing 36.

To keep the Plexiglas housing 36 securely anchored to the bottom of the trap 94 or to a streambed, weights 98 are put at the bottom of the Plexiglas housing 36 (refer to FIG. 1). The amount of weight put in the Plexiglas housing 36 depends on the amount of water displaced by the device.

Although in this preferred embodiment Plexiglas is used for almost all of the invention structures, many other materials could be used instead such as other hard plastics. Furthermore, all of the relative and specific dimensions of the invention can be adjusted to fit a given situation except for four relative dimensions: The lengths of the two horizontal Plexiglas pieces 50 must equal the focal length of the lens 46, minus the distance from the Plexiglas backing 22 to the infrared detector 66. The lens 46 must be placed directly in front of the detector circuit 20. The emitter circuit 24 must be directly across from the detector circuit 20 and lens 46 (refer to FIG. 1). The distance between the emitter circuit 24 and the detector circuit 20 must be significantly greater than the focal length of the lens 46.

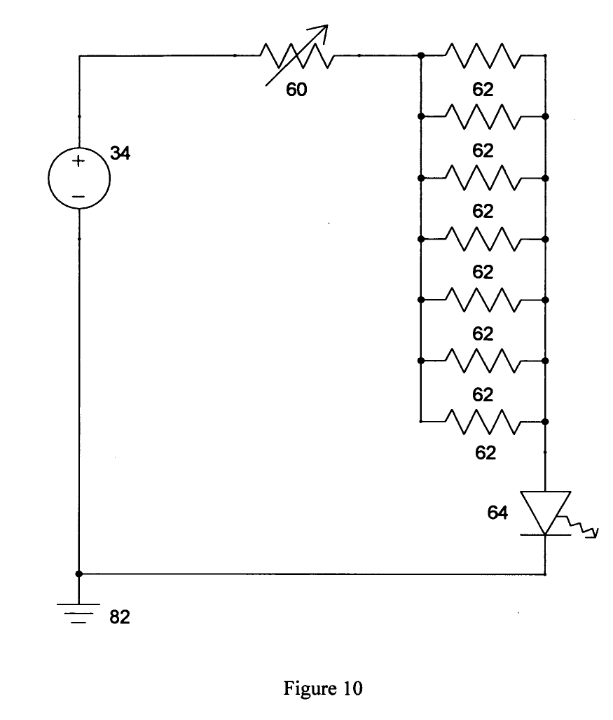

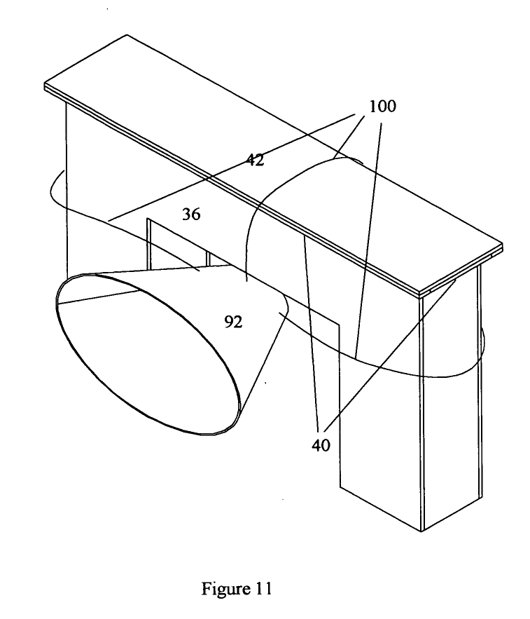

Referring to FIG. 10, the positive terminal of the battery 34 of the emitter circuit 24 is connected to a 1 kΩ variable resistor 60. The other end of the 1 kΩ variable resistor 60 is connected to seven 220Ω resistors 62 in parallel. These 220Ω resistors 62 are then connected to an infrared emitter 64 that has a narrow radiation pattern. The other end of the infrared emitter 64 is connected to ground 82. The negative terminal of the battery 34 is also connected to ground 82.

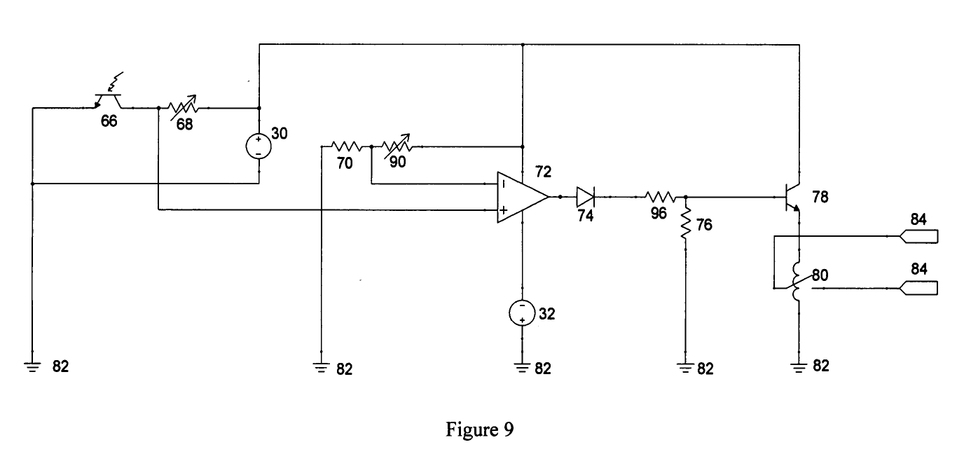

Referring to FIGS. 9 and 13, the infrared detector 66, in the detector circuit 20, is frequency matched to the infrared emitter 64. The emitter pin of the infrared detector 66 is connected to ground 82. The collector pin of the infrared detector 66 is connected to one end of a 5 kΩ variable resistor 68. This same end of the 5 kΩ variable resistor 68 is connected to the non-inverting input of the first operational amplifier of a LF353 Dual Operational Amplifier 72. The other end of the 5 kΩ variable resistor 68 is connected to the positive terminal of the battery 30. The negative terminal of the battery 30 is connected to ground 82, while the positive end of the battery 30 is also connected to the positive voltage input of the op amp 72. A 100 kΩ resistor 70 is connected to ground 82 at one end and to a 5 kΩ variable resistor 90 and the inverting input of the op amp 72 at the other end. The 5 kΩ variable resistor 90 is connected to the positive terminal of the battery 30 at its other end. The negative voltage input of the op amp 72 is connected to the negative terminal of the battery 32. The positive terminal of the battery 32 is connected to ground 82.

The output pin of the op amp 72 is connected to one end of a 1N914 diode 74. The other end of the diode 74 is connected to a 1 kΩ resistor 96. The other end of this 1 kΩ resistor 96 is connected to one end of a 10 kΩ resistor 76 and the base pin of a 2N2222 NPN transistor 78. The other end of the 10 kΩ resistor 76 is connected to ground 82. The collector pin of the transistor 78 is connected to the positive terminal of the battery 30. The emitter pin of the transistor 78 is connected to one activating pin of a 5V DC reed relay 80. The opposite activating pin of this relay 80 is connected to ground 82. The two switched pins of the relay 80 are connected to two PC board terminals 84. The connector plug 104 of the event logger 44 is inserted into the two PC board terminals 84 and secured with integral set screws (refer to FIG. 13). All connections in both the infrared detector circuit 20 and the infrared emitter circuit 24, except the event logger 44 connection, are made using solder and either insulated wire or printed circuits.

### OPERATION—PREFERRED EMBODIMENT—FIGS. 1-14

Referring to FIG. 10, the emitter circuit 24 is comprised of a 6V lantern battery 34, a 1 kΩ variable resistor 60, seven 220Ω resistors 62 in parallel, and an infrared emitter 64. The battery 34 supplies power to the entire emitter circuit 24. The 1 kΩ variable resistor 60, which is preferably set at 15Ω, controls how bright the emitted infrared beam is. If it is desirable to make the infrared beam brighter, one turns the resistance of the 1 kΩ variable resistor 60 down. Likewise, if the infrared beam is too bright or using up too much power from the battery 34, one can turn the resistance of the 1 kΩ variable resistor 60 up.

In the next section of the emitter circuit 24, seven 220Ω resistors 62 in parallel provide approximately 31.4Ω of resistance that limit the maximum current through the emitter 64. In place of the seven 220Ω resistors 62 in parallel, a single or other combination of resistors can be used with an effective resistance of 30Ω to 34Ω and with a sufficient wattage rating. When the infrared emitter 64, the next piece in the emitter circuit 24, receives power from the battery 34, it emits infrared radiation in a conical shape. The magnitude of the brightness of this cone, as stated previously, is determined by the 1 kΩ variable resistor 60.

Referring to FIGS. 4 and 5, the emitter circuit 24 as well as the detector circuit 20 are each attached to separate Plexiglas backings 22 with machine screws 52, nylon spacers 54, washers 58, and nuts 56. Each circuit board has four previously drilled holes through which four screws 52 pass through. After going through the detector circuit 20 and the emitter circuit 24, the screws 52 are put through the spacers 54. These spacers 54 keep the detector circuit 20 and the emitter circuit 24 and the wiring or pin protrusions on their reverse sides from getting screwed down right on top of their Plexiglas backings 22. After the screws 52 are put through drilled holes in the Plexiglas backings 22, the screws 52 are put through the washers 58, then the nuts 56 on the other side of the Plexiglas backings 22 are screwed on to each of the screws 52.

Referring to FIGS. 1-3 and 6-8, the Plexiglas backing 22 for the infrared emitter circuit 24 is placed in between two sets of two thin vertical Plexiglas pieces 27 (refer to FIG. 3). The Plexiglas backing 22 for the detector circuit 20 is similarly placed in between two sets of two thin vertical Plexiglas pieces 26 (refer to FIG. 2). The purpose of these vertical Plexiglas pieces 26 and 27 is to keep the Plexiglas backings 22 of the detector and emitter circuits 20 and 24 upright and horizontally aligned with each other. The Plexiglas backing 22 for the detector circuit 20 is welded to two horizontal Plexiglas pieces 50 which are welded to a vertical Plexiglas piece 48 that holds the focusing lens 46 (refer to FIGS. 1 and 6). The purpose of the lens 46 is to focus the infrared cone that the lens 46 receives from the infrared emitter 64 onto the infrared detector 66. Consequently, the distance from the lens 46 to the infrared detector 66 must be the focal length of the lens 46, and the distance between the emitter circuit 24 and the detector circuit 20 must be significantly greater than the focal length of the lens 46. These two distances allow the maximum percentage of the infrared cone to be focused onto the infrared detector 66. The lens 46 is held in place by four nylon screws 38 and four nuts 56. The nylon screws 38 pass through four previously drilled holes in the Plexiglas and are screwed by four nuts 56 on the reverse side of the Plexiglas lens holder 48. The purpose of the nylon screws 38 is to secure the lens 46 to its Plexiglas lens holder 48. Thus, the nylon screws 38 are positioned so their heads slightly overlap the lens 46, holding it securely to its Plexiglas lens holder 48 (refer to FIGS. 7 and 8).

Referring to FIGS. 9 and 13, the purpose and functioning of the detector circuit 20 is to trigger a HOBO® event logger 44 to record the date and time the infrared cone traveling between the infrared emitter circuit 24 and the infrared detector circuit 20 is cut by a pre-selected size of aquatic animal. It should be noted that in most cases a pre-selected approximate size directly corresponds to a pre-selected-species of aquatic animal. Thus, in recording data for one approximate size of aquatic animal, one is usually recording data for a single species of aquatic animal. In describing the functioning of the first half of the detector circuit 20 before the LF353 Dual Operational Amplifier 72, the Oregon spotted frog (Rana pretiosa) will be used as the pre-selected species size of aquatic animal that one wants to monitor. Using specific values for variable resistances and voltage drops, when the infrared detector 66 is on, meaning it is receiving the infrared cone from the infrared emitter 64, 6V from the battery 30 goes to the 5 kΩ variable resistor 68 set at 3.35 kΩ, gets dropped to approximately 0.5V, and goes into the non-inverting input of the op amp 72. The same 6V from the battery 30 also goes to the 5 kΩ variable resistor 90 which is set at 4.81 kΩ. The 5 kΩ variable resistor 90 drops the 6V down to approximately 5.5V, which goes into the inverting input of the op amp 72. The function of the 100 kΩ resistor 70 connected to the 5 kΩ variable resistor 90 is to limit the current and, in conjunction with the variable resistor 90, set the voltage at the inverting input of the op amp 72.

For the op amp 72 to function, it needs a negative voltage input and a positive voltage input. It receives the positive voltage input from the positive terminal of the battery 30, and the negative voltage input from the negative terminal of the battery 32.

At this point in the detector circuit 20, the inverting input voltage, approximately 5.5V, is much larger than the non-inverting input voltage at approximately 0.5V. Consequently, the op amp 72 is going to put out an amplified negative voltage. This negative voltage will not get past the following 1N914 diode 74, and thus no power will get through the rest of the detector circuit 20 to trigger the event logger 44 connected to the PC board terminals 84 at the end of the detector circuit 20 (refer to FIG. 13).

When the infrared detector 66 is completely off, meaning there is no infrared radiation reaching the detector, the 5 kΩ variable resistor 68 conducts no current and the full 6V from the battery 30 is seen at the non-inverting input of the op amp 72. The non-inverting voltage is now greater than the inverting voltage, so the op amp 72 will put out a positive voltage, which will pass through the diode 74 and allow power to get to the relay and trigger the event logger 44. The conclusion from the above is that when the infrared cone from the infrared emitter circuit 24 is broken enough, or has a great enough percentage of its cone blocked by an aquatic animal, an event will be recorded. At a resistance of 3.35 kΩ for the 5 kΩ variable resistor 68 and 4.81 kΩ for the 5 kΩ variable resistor 90, an Oregon spotted frog cuts enough of the infrared cone to make the non-inverting input voltage greater than the inverting input voltage, triggering the event logger 44.

This detector circuit 20 can be adjusted to detect other sizes of aquatic animals. One simply adjusts the two 5 kΩ variable resistors 68 and 90 up or down to detect a larger or smaller size of aquatic animal.

To require a size of aquatic animal larger than the Oregon spotted frog to trigger the event logger 44, one first decreases the resistance of the 5 kΩ variable resistor 90 which increases the voltage of the inverting input of the op amp 72, requiring higher voltage between the 5 kΩ variable resistor 68 and the infrared detector 66, which means the infrared cone needs to be blocked more. If one still needs a greater percentage of the infrared cone to be broken, one increases the resistance of the 5 kΩ variable resistor 68 as well. If the previous percentage of infrared radiation is being blocked so that the voltage at the non-inverting pin of the op amp 72 is barely greater than the voltage at the inverting pin of the op amp 72, then increasing the resistance in the 5 kΩ variable resistor 68 would cause the voltage drop across the resistor to increase, which means that the voltage seen at the inverting input of the op amp 72 would decrease. The previous percentage of the infrared cone blockage would no longer trigger an event. A larger size of aquatic animal would be required to trigger an event. To allow a smaller aquatic animal to trigger the event logger 44, one first increases the 5 kΩ variable resistor 90. Then, if necessary, one decreases the other 5 kΩ variable resistor 68 as well to allow a smaller percentage of the cut infrared cone to trigger the event logger 44.

After the op amp 72 puts out an amplified positive voltage, current passes through the diode 74 and through the 1 kΩ resistor 96. The combination of the 10 kΩ resistor 76 connected to the 1 kΩ resistor 96 establishes a triggering voltage and limits the current output of the op amp 72. The 1 kΩ resistor 96 is also connected to the base of a 2N2222 NPN transistor 78, which controls the high current path through the relay 80. The collector of the transistor 78 is connected to directly to the battery 30. The emitting end of the transistor 78 is connected to one activating pin of a 5V DC reed relay 80. The other activating pin of the relay 80 is connected to ground 82. When current passes through the transistor 78 to the relay 80 and through the coil of the relay 80, the switch inside the relay 80 closes and connects the two PC board terminals 84, which are connected to the event logger 44. The event logger 44, when its pins are shorted, records the date and time of the event. This event, once again, came as a result of an aquatic animal cutting the infrared cone enough to make the voltage in the non-inverting input of the op amp 72 greater than the voltage in the inverting input of the op amp 72.

Referring to FIGS. 11 and 12, one significant advantage of this device is that it allows one to collect data on a single approximate size of aquatic animal. It accomplishes this by establishing a minimum size of aquatic animal to be able to trigger the event logger 44 through adjusting the settings of the 5 kΩ variable resistor 68 and the 5 kΩ variable resistor 90 of the detector circuit 20. A maximum size results from the funnel mouth diameter of funnel 92 or funneled trap 94 where the funnel in each case is situated directly behind the infrared cone. This approximate size, in most environments, directly correlates to a single species of aquatic animal. Smaller aquatic animals cannot break enough of the infrared cone to make the voltage at the non-inverting input of the op amp 72 larger than the voltage at the inverting input of the op amp 72. Consequently, no current gets to the relay 80 and no event is recorded by the event logger 44. Likewise, larger aquatic animals are prevented from breaking the infrared cone and triggering the event logger 44 when the mouth of the funnel of the mesh funnel 92, or of the funneled trap 94, is too small for the larger aquatic animals to pass through (refer to FIGS. 11 and 12). If they cannot pass through the funnel 92 or through the funnel of trap 94, they cannot break the infrared cone.

Referring to FIGS. 11-12 and 14, the black Plexiglas housing 36 serves two purposes. First, it functions as waterproof protection for the circuitry inside. Second, the fact that it is made out of black Plexiglas allows the Plexiglas housing 36 to eliminate some of the infrared radiation coming from the sun that might affect the circuitry and the infrared cone going from the emitter circuit 24 to the detector circuit 20. The Plexiglas housing 36 should be placed in an area where the majority of the aquatic amphibians or other aquatic animals pass through the infrared cone in between the emitter circuit 24 and the detector circuit 20. To ensure that the aquatic animals of a pre-selected size do not swim above or below the infrared cone, the Plexiglas housing 36 should either be placed in a trap with a funnel-type opening 94 (refer to FIG. 12), or have a mesh funnel 92 put on the Plexiglas housing 36 (refer to FIG. 11).

The Plexiglas cover 42 is secured to the Plexiglas flanges 40 with machine screws 52 and wing nuts 88 through previously drilled holes. The four welded Plexiglas flanges 40, one on each edge of the rim of the Plexiglas housing 36 (refer to FIG. 14), provide a stable surface for the Plexiglas cover 42 to attach to. The wing nuts 88 allow the Plexiglas cover 42 to stay securely attached to the Plexiglas flanges 40 and the rest of the housing 36 and is easy to remove as well. In this preferred embodiment the seam between the Plexiglas cover 42 and the Plexiglas housing 36 is not watertight. Consequently that seam must remain above the water.

### CONCLUSION, RAMIFICATIONS, AND SCOPE

Thus the reader will see that the non-invasive active infrared triggering device to monitor amphibian and other animal life in aqueous environments provides a new and enormously useful system for studying the movement patterns and thus key behavioral traits of aquatic amphibians and other aquatic animals. This active infrared monitoring device can be adjusted to record the date and time a single pre-selected size of aquatic animal, and by extension a pre-selected species of aquatic animal, passes a monitored location and breaks the infrared beam, providing scientists with an enabling tool for aquatic species research. While the above description contains many specificities, these should not be construed as limitations on the scope of the invention, but as exemplifications of the presently preferred embodiments thereof. Many other ramifications and variations are possible within the teachings of the invention. For example,
instead of using Plexiglas for the majority of the structural aspects of the invention, materials like other hard plastics could be used;
instead of using infrared detectors and emitters, higher or lower frequency emitters and detectors could be used;
instead of using one lens, a pair of lenses could be used to first parallelize the radiation beam across the detector area, and then focus it on the detector;
instead of using 6V lantern batteries, combinations of lower voltage batteries, rechargeable batteries, and/or solar panels or other recharging systems could be used;
the HOBO® event logger could be replaced with another apparatus that records the date and time of an event and can plug into the PC board terminals of the detector circuit, such as the Madge Tech event logger among others;
the Plexiglas housing can be made any size to fit a situation, although the active infrared detector and emitter should remain within two feet of each other, allowing the lens to focus enough of the infrared cone from the emitter onto the detector;
the housing can be any shape, as long as the active infrared emitter and detector are horizontally oriented and aligned with each other;
the active infrared monitor can function on land;
the seam between the Plexiglas housing and the Plexiglas cover can be made water-tight, allowing the housing to submerge completely.

Thus the scope of the invention should be determined by the appended claims and their legal equivalents, and not by the examples given.

The invention claimed is:

1. An apparatus for recording the movement of aquatic amphibians and other aquatic animals past a pre-selected aqueous location, said apparatus comprising:
a. means for directionally transmitting infrared energy in a path intersecting said pre-selected aqueous location in a continuous beam;
b. infrared sensitive receiving means placed along said path to detect said continuous beam;
c. said infrared sensitive receiving means operable to provide an electrical signal indicative of the presence of a target aquatic animal whenever a predetermined percentage of said continuous beam is not detected by said infrared sensitive receiving means; and
d. means associated with said infrared sensitive receiving means for transmitting said electrical signal to an event logger with the means to record the date and time upon the receipt of each said electrical signal.

2. The apparatus of claim 1, including means for varying the predetermined percentage of the continuous beam.

3. The apparatus of claim 1, wherein the means for directionally transmitting infrared energy and the infrared sensitive receiving means further comprises a waterproof housing.

4. The apparatus of claim 3, wherein the waterproof housing comprises means for funneling aquatic animals through the continuous beam.

5. The apparatus of claim 1, wherein the means for directionally transmitting infrared energy and the infrared sensitive means are horizontally opposed to each other.

6. The apparatus of claim 1, wherein the infrared sensitive means comprises a focusing lens.
